(19) United States
(12) Patent Application Publication
(10) Pub. No.: US 2025/0333279 A1
(43) Pub. Date: Oct. 30, 2025

(54) BARREL LIFTING ATTACHMENT FOR A FORK LIFT

(71) Applicant: Koetter-Rax, LLC, Floyds Knobs, IN (US)

(72) Inventors: Robert J. Koetter, JR., Floyds Knobs, IN (US); Anthony Ferrera, Crestwood, KY (US)

(21) Appl. No.: 19/182,836

(22) Filed: Apr. 18, 2025

Related U.S. Application Data
(60) Provisional application No. 63/637,935, filed on Apr. 24, 2024.

(51) Int. Cl. B66F 9/18

(52) U.S. Cl. CPC B66F 9/187

(57) ABSTRACT

A barrel lifting attachment for a fork lift includes a frame pivotally attached to the forks toward their front and a hydraulic cylinder piston attached to an extension on the back of the frame. A rear wheel assembly is attached to each side of the frame in front of the extension. The top of the hydraulic cylinder is attached to a piston mounting structure attached to the upright portion of the forks. A front wheel assembly is attached to each fork toward their fronts. A ramp is attached to each of the forks forward of the front wheel assembly. With the frame in a horizontal position, a barrel can be rolled onto the ramps and cradled between the front and rear wheel assemblies. To remove the barrel the piston is engaged to raise the rear of the frame so that the barrel can be removed from the attachment.

### CROSS REFERENCE TO RELATED APPLICATION

This application claims priority to U.S. Provisional Application 63/637,935, filed 24 Apr. 2024, incorporated herein by reference.

### FIELD OF THE INVENTION

The present invention relates to a barrel lifting attachment for a fork lift.

### BACKGROUND OF THE INVENTION

For hundreds of years, alcoholic beverages have been aged and stored in barrels. Barrels themselves are often stored in specially configured buildings, referred to as rickhouses. A typical rickhouse includes a plurality of “ricks,” or racks that store lines of barrels on their sides, typically three barrels high. A rick may include multiple horizontally aligned barrel aisles, typically with a walkway for workers extending along at least one side of each aisle. Workers may move along the walkways, manually rolling barrels along the ricks. A typical rickhouse is several stories high, such that a four story rickhouse would include four stacked ricks, one per story, each rick holding three vertically stacked lines of barrels arranged on their sides in each of a plurality of barrel aisles.

Barrels are added to a rick for storage, removed for dumping, or may be rearranged in a rickhouse for various reasons. A typical newly filled bourbon barrel contains about 53 gallons of liquid and weighs about 550 lbs. For horizontal movement of a barrel in a rickhouse, the barrel is manually rolled along the floor by one or more workers. For vertical movement of a barrel, many rickhouses include a small, dedicated elevator typically referred to as a “ricker.” A typical ricker is configured to raise and lower a barrel to all three levels of barrels in a rick on a given floor. However, if a rickhouse is designed with more than three levels per floor, or the rickhouse does not include a floor suitable for operation of a ricker on every story of the building, use of a ricker may not be feasible and alternative methods are necessary to load and unload barrels directly from ground level. This function may be performed by a standard forklift by positioning the forks relatively close together and arranging a barrel between and supported by the forks. However, a barrel arranged with its axis perpendicular to the forks has a tendency to roll off the forks during the lifting or lowering process, while a barrel arranged with its axis parallel to the forks is not aligned to roll between the forks and the rick and must be manually turned.

Each barrel includes a bung hole in its side, sealed with a bung, for adding and removing liquid from the interior of the barrel. A barrel is typically stored on its side with its bung in a generally upright position. Before rolling a barrel into a rick, it must be rotated on its axis to an orientation so that that the bung will be upright when the barrel reaches its final position. This process is referred to as “clocking,” as a properly clocked barrel will end with its bung in an upright or “12 o'clock” orientation. Clocking is typically manually performed when positioning the barrel on the ricker, standard forklift, or other means for vertical movement, prior to lifting the barrel to the proper height for loading into a rick. Due to the size and weight of the barrel, clocking is a physically strenuous process.

The inventors of the present invention realized that improvements are needed in barrel storage, particularly in the vertical transportation and clocking of barrels. Certain features of the present invention address these and other needs and provide other important advantages.

### SUMMARY

The present invention relates to a barrel lifting attachment for a fork lift. A frame is pivotally attached to the forks toward their front and a hydraulic cylinder piston is attached to an extension on the back of the frame. A rear wheel assembly is attached to each side of the frame in front of the extension at the back of the frame. The top of the hydraulic cylinder is attached to a piston mounting structure which is attached to the upright portion of the forks. A front wheel assembly is attached to each fork toward their fronts, a fixed stop is attached to the forks and transverse thereto, the fixed stop being in front of the front wheel assembly, as it serves as a guide to prevent the forks from being moved too far into a rick barrel row. A ramp is attached to each of the forks forward of the front wheel assembly and a strength member is attached to both forks between the attached ramps. With the piston having the frame in a horizontal position, a barrel can be rolled onto the ramp and cradled between the front and rear wheel assemblies. To remove the barrel the piston is engaged to raise the rear of the frame so that the barrel can be removed from the attachment.

More particularly, the present invention for a barrel lifting attachment for a fork lift can include a pair of forks, each fork having a top, a fork shank extending downward from the top, a fork blade extending outward from the fork shank and terminating in a fork tip; a strength member connected between the pair of forks on insides of the fork blades toward the fork tips; a frame connected between the pair of forks creating a frame pivot point, the connection being on insides of the fork blades at a location further from the fork tips than where the strength member is attached, the frame extending toward the fork shanks, the frame having a rear extension member extending away from the fork tips toward the fork shanks; a piston mounting structure having a horizontal member with a bracket attached to each end of the horizontal member, each bracket attached to the fork shanks on their insides near the top of each fork; a hydraulic cylinder having a non-piston end attached to the piston mounting structure's horizontal member such that a piston extends downward away from the horizontal member, the piston having a piston end, the piston end attached to the frame's rear extension member; the hydraulic cylinder operable to extend the piston so that the frame moves downward as allowed by the pivot point or operable to retract the piston so that the frame moves upward as allowed by the pivot point.

Also, a pair of wedge members can be included, each wedge member attached across from each other to a top surface of the fork blades at a location on the forks where the strength member is attached, the wedge members sloping upward from their front portions facing the fork tips back toward the fork shafts. The attachment can include a front wheel assembly having a pair of mounting assemblies, each mounting assembly attached to the tops of the fork blades at a location further from the fork tips than the strength member, the front wheel assembly including a pair of front wheels, each front wheel attached to one of the mounting assemblies and located outside of both forks; and a rear wheel assembly having a pair of frame attachment assemblies, each frame attachment assembly attached to the frame at a location further from the fork tips than the front wheel assembly, the rear wheel assembly including a pair of rear wheels, each rear wheel attached to one of the attachment assemblies and located outside of the forks. Also, the attachment can include fixed stops extending outward from each fork blade at a location between the front wheel assembly and the fork tips, as well as a pair of barrel stop members, each barrel stop member attached to one of the fork shanks at a location toward the top of each fork shank. Additionally, the piston end can be attached to the frame's rear extension member using a pinned clevis member. Further, the frame can include a pair of front side members each front side member connected toward their fronts to the insides of the fork blades forming the frame pivot point, the front side members having a front member extending thereacross at a location to the rear of the frame pivot point, the front side members having a rear member extending thereacross at ends of the front side members, the rear member having the rear extension member attached thereto and extending away from the fork tips. Further, the front and rear wheels can be oriented so that a barrel received by the barrel lifting attachment is cradled by the front and rear wheels.

A barrel lifting attachment for a fork lift of the present invention can include a pair of forks, each fork having a top, a fork shank extending downward from the top, a fork blade extending outward from the fork shank and terminating in a fork tip, the pair of forks in a fixed relationship to each other by having a strength member connected between the pair of fork blades toward the fork tips and a piston mounting structure attached to the fork shanks near the top of each fork; a frame connected between the pair of forks creating a frame pivot point, the connection being at a location further from the fork tips than where the strength member is attached, the frame extending toward the fork shanks, the frame having a rear extension member extending away from the fork tips toward the fork shanks; and a hydraulic cylinder having a non-piston end attached to the piston mounting structure such that a piston extends downward away from the piston mounting structure, the piston having a piston end, the piston end attached to the frame's rear extension member; the hydraulic cylinder operable to extend the piston so that the frame moves downward as allowed by the pivot point or operable to retract the piston so that the frame moves upward as allowed by the pivot point.

The barrel lifting attachment can further include a pair of wedge members, each wedge member attached across from each other to a top surface of the fork blades at a location on the forks where the strength member is attached, the wedge members sloping upward from their front portions facing the fork tips back toward the fork shafts. Also, the attachment can include a front wheel assembly having a pair of mounting assemblies, each mounting assembly attached to the tops of the fork blades at a location further from the fork tips than the strength member, the front wheel assembly including a pair of front wheels, each front wheel attached to one of the mounting assemblies and located outside of both forks; and, a rear wheel assembly having a pair of frame attachment assemblies, each frame attachment assembly attached to the frame at a location further from the fork tips than the front wheel assembly, the rear wheel assembly including a pair of rear wheels, each rear wheel attached to one of the attachment assemblies and located outside of the forks. Fixed stops can be included which extend outward from each fork blade at a location between the front wheel assembly and the fork tips. a pair of barrel stop members can also be included, each barrel stop member attached to one of the fork shanks at a location toward the top of each fork shank. It is noted that the piston end can be attached to the frame's rear extension member using a pinned clevis member.

The frame of the barrel lifting attachment can have a pair of front side members, each front side member connected toward their fronts to the insides of the fork blades forming the frame pivot point, the front side members having a front member extending thereacross at a location to the rear of the frame pivot point, the front side members having a rear member extending thereacross at ends of the front side members, the rear member having the rear extension member attached thereto and extending away from the fork tips. Even further, the front and rear wheels can be oriented so that a barrel received by the barrel lifting attachment is cradled by the front and rear wheels.

The present invention also includes a method for a fork lift operator to operate a fork lift having the barrel lifting attachment of the present invention attached to the fork lift to move a barrel from a first location to a second location which includes the steps of positioning the fork lift at the first location with the piston extended so that the rear wheel assembly is lowered and the fork tips are positioned so that a barrel can be received onto the fork blades; rolling a barrel onto the fork blades and up the ramps to be received into front and rear wheel assemblies and be cradled therein by the front and rear wheels; moving the fork lift to the second location and positioning the fork tips for removal of the barrel; and retracting the piston so that the rear wheel assembly is raised with respect to the front wheel assembly causing the barrel to then roll down the ramps and off the fork blades to be removed at the second location. When the barrel is cradled by the front and rear wheel assemblies and supported by the front and rear wheels, the barrel is rotatable so that the barrel is clocked or positioned so that a bung inserted into the barrel is repositioned so that the bung is in the desired orientation when the barrel is removed at the second location.

Where the second location is a rick in a rickhouse, positioning the fork tips for removal of the barrel involves inserting the fork tips into the desired rick until the fixed stops prevent further insertion of the fork blades into the rick.

Where the first location is a rick in a rickhouse, positioning the fork tips so that a barrel can be received onto the fork blades involves inserting the fork tips into the desired rick until the fixed stops prevent further insertion of the fork blades into the rick.

It will be appreciated that the various systems and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

A better understanding of the present invention will be had upon reference to the following description in conjunction with the accompanying drawings.

FIG. 1 is a front left perspective view of the barrel lifting attachment for forklifts with the rear of the barrel receiving bracket lowered.

FIG. 2 is a front view of the barrel lifting attachment for forklifts with the rear of the barrel receiving bracket lowered.

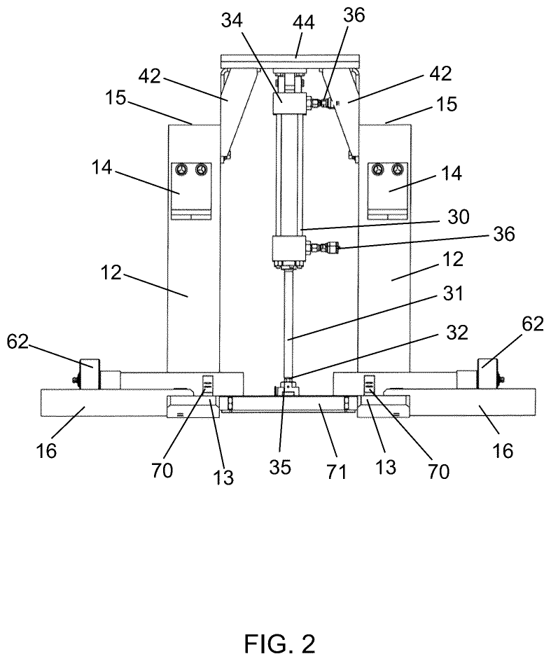

FIG. 3 is a left side view of the barrel lifting attachment for forklifts with the rear of the barrel receiving bracket lowered.

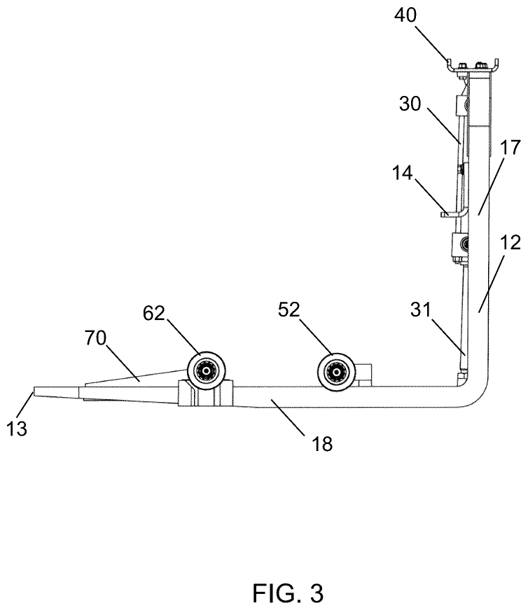

FIG. 4 is a right side view of the barrel lifting attachment for forklifts with the rear of the barrel receiving bracket lowered.

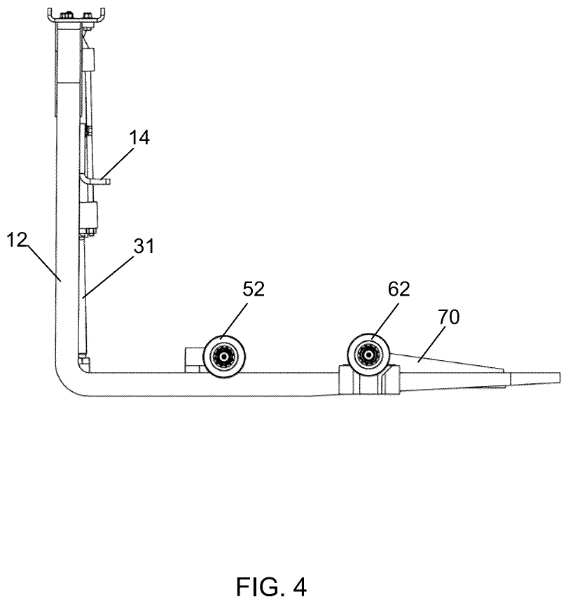

FIG. 5 is a top view of the barrel lifting attachment for forklifts with the rear of the barrel receiving bracket lowered.

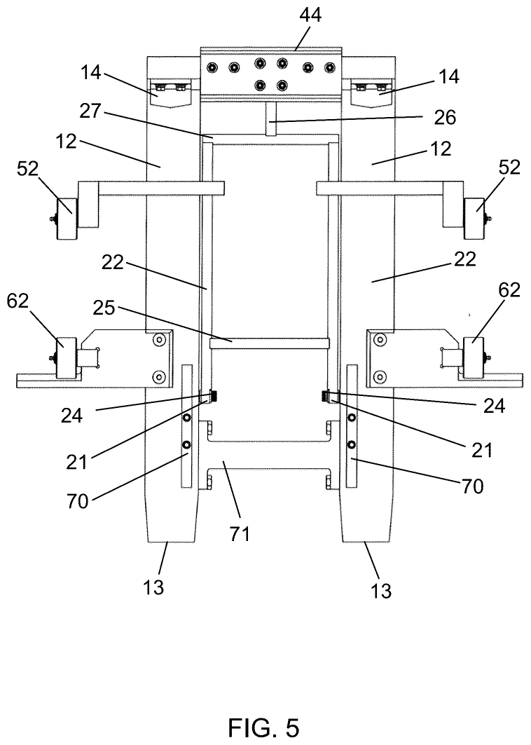

FIG. 6 is a bottom view of the barrel lifting attachment for forklifts with the rear of the barrel receiving bracket lowered.

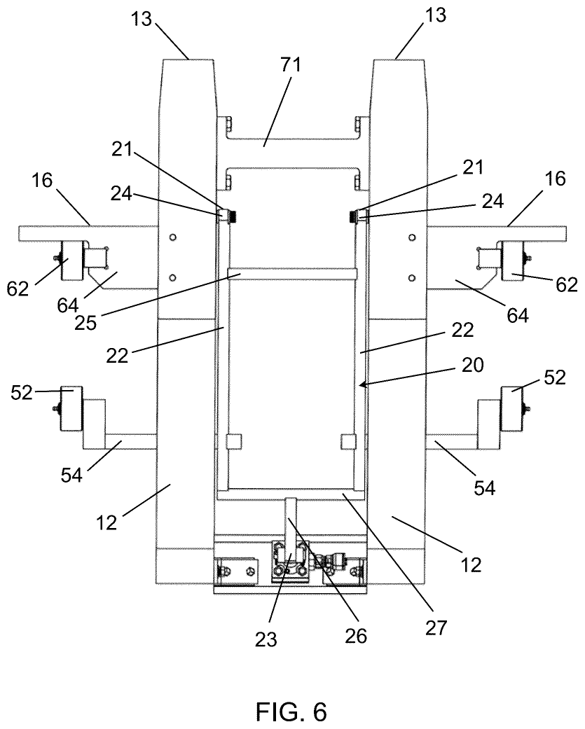

FIG. 7 is a rear view of the barrel lifting attachment for forklifts with the rear of the barrel receiving bracket lowered.

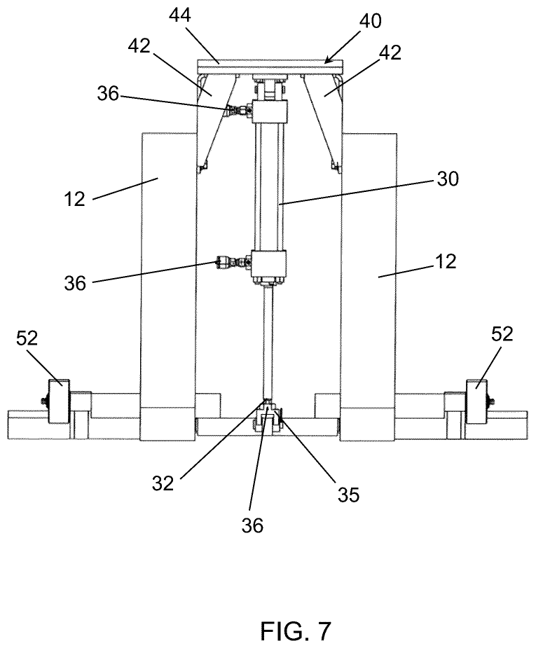

FIG. 8 is a front left perspective view of the barrel lifting attachment for forklifts with the rear of the barrel receiving bracket raised.

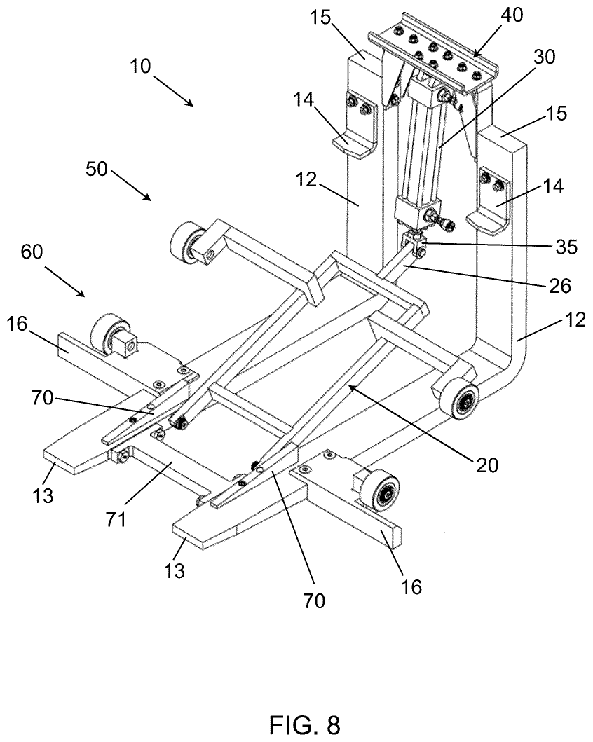

FIG. 9 is a front view of the barrel lifting attachment for forklifts with the rear of the barrel receiving bracket raised.

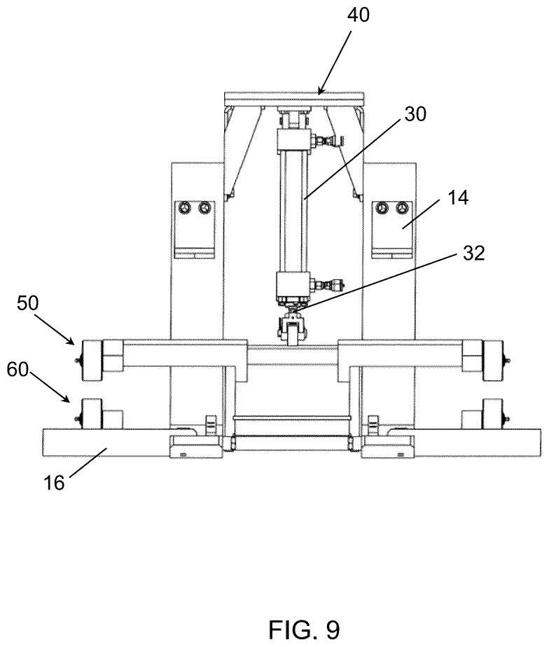

FIG. 10 is a left side view of the barrel lifting attachment for forklifts with the rear of the barrel receiving bracket raised.

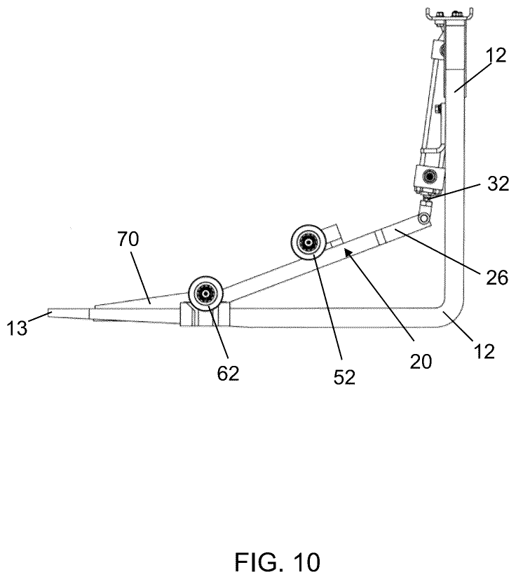

FIG. 11 is a right side view of the barrel lifting attachment for forklifts with the rear of the barrel receiving bracket raised.

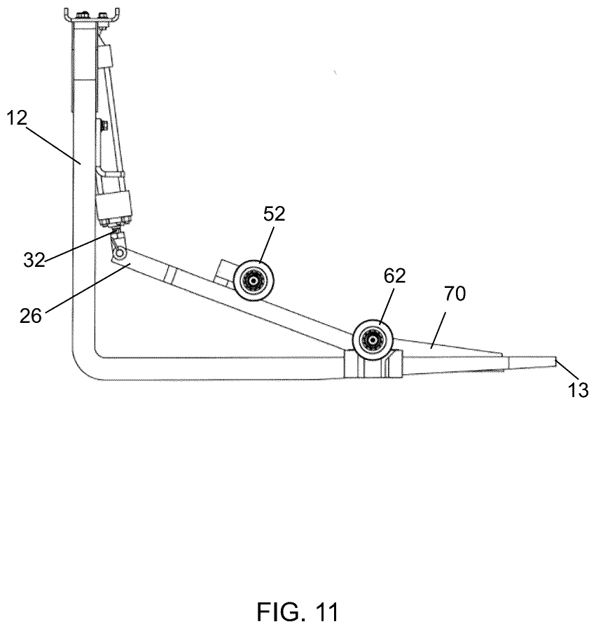

FIG. 12 is a top view of the barrel lifting attachment for forklifts with the rear of the barrel receiving bracket raised.

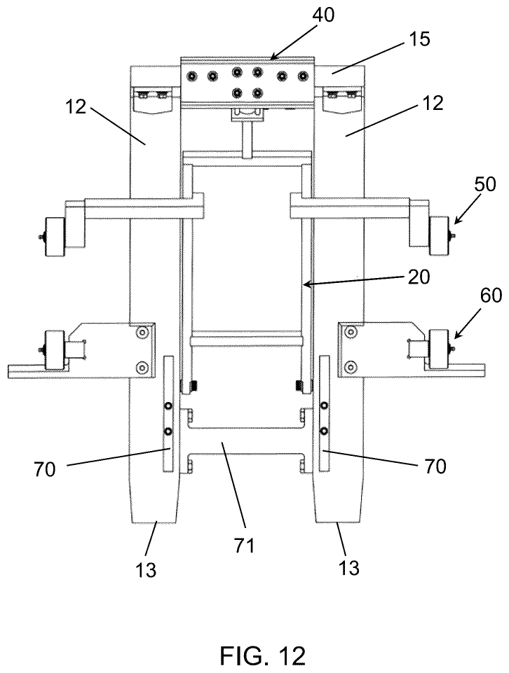

FIG. 13 is a bottom view of the barrel lifting attachment for forklifts with the rear of the barrel receiving bracket raised.

FIG. 14 is a rear view of the barrel lifting attachment for forklifts with the rear of the barrel receiving bracket raised.

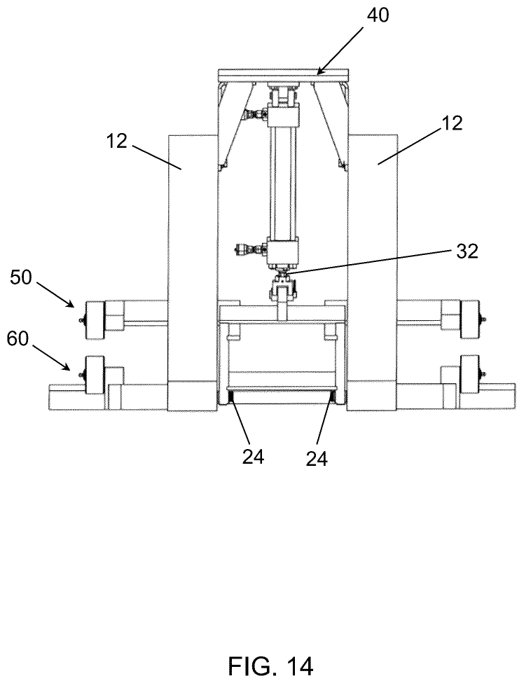

FIG. 15 is a left side view of the barrel lifting attachment for forklifts with the rear of the barrel receiving bracket lowered, the vertical and a portion of the left fork removed to show the piston location in the hydraulic cylinder.

FIG. 16 is a left side view of the barrel lifting attachment for forklifts with the rear of the barrel receiving bracket raised, the vertical and a portion of the left fork removed to show the piston location in the hydraulic cylinder.

### DETAILED DESCRIPTION OF THE PREFERRED EMBODIMENTS

The details of one or more embodiments of the presently-disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

Unless defined otherwise, all technical and scientific terms used herein have the same meaning as commonly understood by one of ordinary skill in the art to which the presently-disclosed subject matter belongs. Although any methods, devices, and materials similar or equivalent to those described herein can be used in the practice or testing of the presently-disclosed subject matter, representative methods, devices, and materials are now described.

Following long-standing patent law convention, the terms “a”, “an”, and “the” refer to “one or more” when used in this application, including the claims. Thus, for example, reference to “a cell” includes a plurality of such cells, and so forth.

Unless otherwise indicated, all numbers expressing quantities of ingredients, properties such as reaction conditions, and so forth used in the specification and claims are to be understood as being modified in all instances by the term “about.” Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount is meant to encompass variations of ±10% of the most precise digit in the value or amount (e.g., “about 1” refers to 0.9 to 1.1, “about 1.1” refers to 1.09 to 1.11, etc.).

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

A typical bourbon barrel 2 is a large wooden container usually constructed from oak and contains about 53 gallons. An empty barrel 2 weighs about 100 pounds and a full barrel weighs about 550 pounds. The top and bottom heads of a barrel are around 21 inches in diameter. Curved staves form the barrel and the barrel has a diameter of about 26 inches at its largest mid-portion. A barrel 2 is generally about 36 inches in height. A bung hole about 2 inches in diameter is drilled into a stave about the widest diameter portion of the barrel. Once a barrel is filled with bourbon and a bung 4 inserted into the bung hole, the barrel 2, with its bung 4 upward, is usually stored for several years for bourbon aging. As storage areas, such as a rickhouse, have differing characteristics, such as differing temperatures or humidity in differing storage areas, barrels being aged are often moved to differing locations in the storage area over the aging period. The present invention allows for barrels 2 to be stored and moved within a facility.

The present invention is a barrel lifting attachment 10 for forklifts, as shown in the drawings. This attachment 10 can be used on fork trucks with 4-axis operation: Lift, Tilt, Side to Side and Fork positioning. Since the unit utilizes the forks as an integral feature to the design, the 4^{th} axis; Fork positioning is not used. Fork positioning allows for the individual forks 12 to move closer together or further apart, individually or in conjunction with each other. The fork positioning functionality is not used in the present invention, which allows the forklift's pressure & tank return lines typically used for this axis to instead operate the attachment 10.

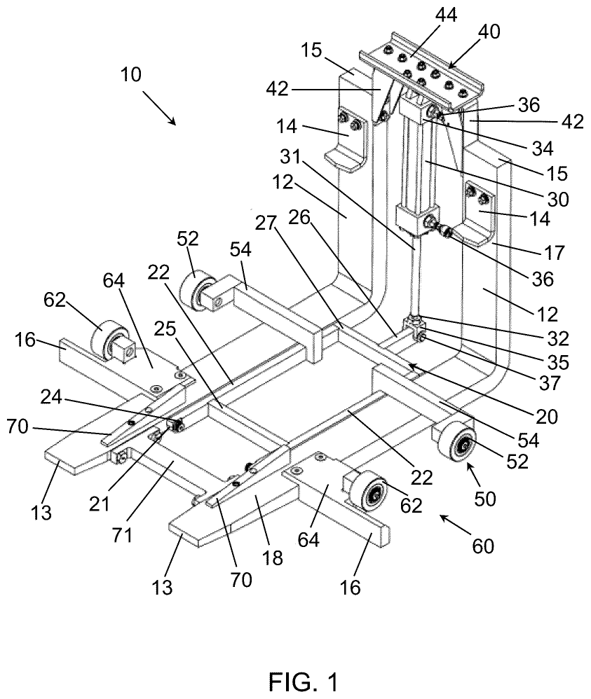

As seen in FIG. 1, forks 12 each have a top portion 15 and a fork front or fork tip 13. The portion of each fork 12 from the top 15 downward is the fork shank 17 and the portion of each fork 12 from the fork tip 13 backward is the fork blade 18. The attachment 10 incorporates standard forks 12 for a fork truck with standard mounting between forks 12 and truck. For example, a fork truck typically has a forklift carriage assembly in front of the forklift mast and opposing top and bottom fork hooks attached to the reverse side of the shank 17 of each fork 12 are used to attach the forks 12 of the attachment 10 to the forklift carriage assembly. Forks 12 are reworked to allow the components described herein to be attached.

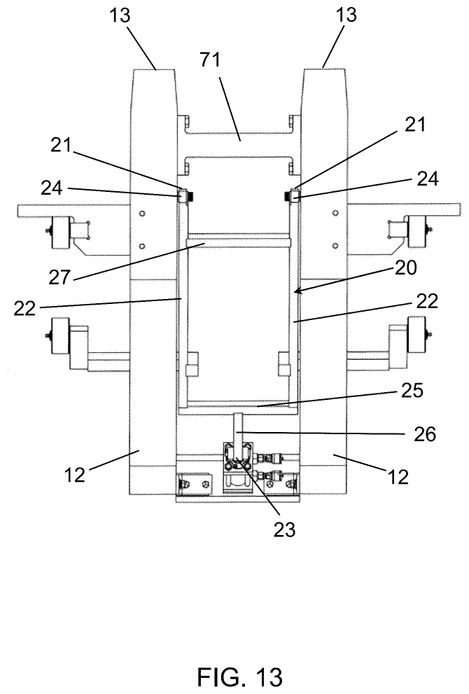

A rear wheel assembly 50 is fabricated and attached to a frame 20. Frame 20 has a front 21 and a back 23 and a pivot point 24, and includes a pair of front side members 22, front cross member 25, rear cross member 27, and a back extension member 26, as best seen in FIG. 13. Rear wheel assembly 50 includes a pair of wheels 52, each wheel 52 attached to a frame attachment assembly 54. Each frame front side 22 is attached to the two forks 12 toward their front 13 and are the frame front pivot points 24. The piston end 32 has a clevis 35 pinned thereto by having the pin 36 inserted through the clevis 35 and a hole near the piston end 32. The back 23 of the frame 20 has a back frame extension 26 which has an opening therethrough and has a rod 37 extending through the back frame extension 26 opening and the clevis 35 to attach the piston end 32 and the extension 26.

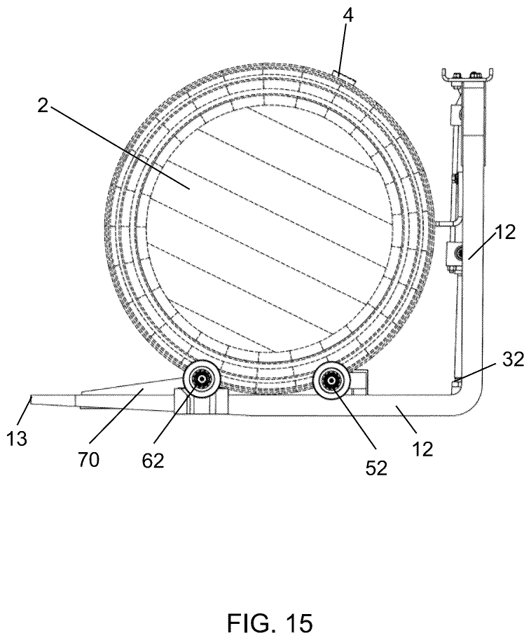

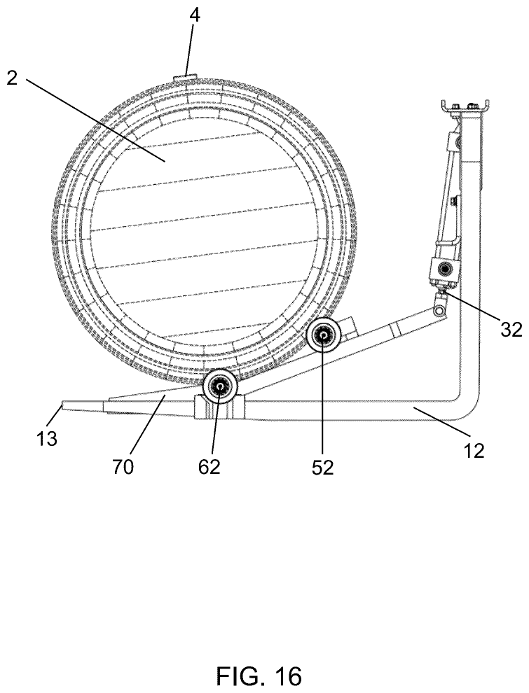

The hydraulic cylinder 30 is at the rear of the unit closest to the fork truck mast (not shown). The non-piston end 34 of the hydraulic cylinder 30 is attached to a piston mounting structure 40's horizontal member 44 at the top of the forks 12. Gusseted bracket members 42 connect the horizontal member 44 to the forks 12 near the fork tops 15. The gusseted brackets 42 improve rigidity and connection life over a 90 degree angle iron bracket. The hydraulic cylinder 30 is connected to the pressure and tank return lines using hydraulic connector fittings 36 for the previously mentioned 4^{th} axis and the operator can then actuate the piston 31 of cylinder 30 up & down via the 4^{th} axis control lever located at the operator control station of the fork truck. With reference to FIGS. 15 and 16, FIG. 15 shows the piston end 32 extended downward so that frame 20 is in a horizontal position, while FIG. 16 shows the operator has moved the piston end 32 upward so that frame 20 has now pivoted upward around front pivot points 24.

Mounted away from the mast and toward the front 13 of the forks 12 is front wheel assembly 60. Assembly 60 has two wheels 62, each wheel 62 attached to a fixed fork mount assembly 64. Each mount assembly 64 is attached to a different fork 12. Mounted ahead of the mount assemblies 64, each fork 12 has a wedge shaped ramp attached thereto. Ramps 70 assist in rolling the barrels 2 onto/off the barrel lifting attachment 10. An added strength member 71 is attached to and positioned between the forks 12 and between ramps 70. Member 71 prevents the forks 12 from spreading apart due to repeated barrel on and off-loading. The front 60 and rear 50 wheel assemblies are sized and located so that curved barrels 2 can easily be loaded and unloaded (particularly as shown in FIGS. 15 and 16), as well as making it easy for each barrel 2 to be clocked so that the bung 2 will be in the proper upright position when the barrel 2 is in its storage location in a barrel roll. Further, wheels 52 and 62 are hardened for improved wear and life.

The frame 20 connections—item 22 to item 27, item 22 to item 25, item 25 to item 26, and item 22 to item 54 are preferably mortise/tenon connections for added strength.

On the vertical portion of each fork 12, a stop 14 is attached to prevent a barrel 2 from hitting the hydraulic cylinder 30. Toward the front 13 of the horizontal portion of the forks 12 is a fixed stop 16 extending outward from each fork 12 which serves as a guide which prevents the forks 12 from being moved too far into a rick barrel row. This helps ensure proper fork location for loading and unloading a barrel 2 in and from a rick row.

Operation—Loading barrels 2 into rick—The fork truck is turned on and forks 12 are lowered to the ground. Operator makes sure that the piston 31 of the cylinder 30 is extended and rear wheel assembly 50 is all the way down. An operator rolls a barrel 2 up the ramps 70 until barrel 2 falls into both wheel assemblies 50/60, so that barrel 2 is cradled therein, as seen in FIG. 15. Using the wheels 52/62, the operator rotates the barrel 2 manually until bung hole with bung 4 is in desired position for clocking the barrel. The fork truck driver then raises forks 12 to desired rick height and positions the barrel 2 at the entry point of the rick. The fork fronts 13 of the forks 12 of attachment 10 can partially penetrate into the rick opening as constrained by fixed stop 16. As the position is achieved, the fork truck operator is adjusting height and side to side positioning within the entry point for adequate position relation between the forks 12 and the rails of the rick. Once in position, the fork truck operator pulls the 4^{th} axis lever and the piston 31 of hydraulic cylinder 30 retracts thereby raising the rear wheel assembly 50, as seen in FIG. 16. This causes the barrel 2 to lift out of all 4 wheels 52/62 and roll down ramps 70 and onto rails of the rick. The fork truck is moved out of rick and attachment 10 lowered so that the process can be repeated, if desired.

Operation—Removing barrels 2 from rick—The fork truck is positioned at entry point of rick just like when loading. The fork truck operator insures that the piston 31 of the hydraulic cylinder 30 is extended making rear wheels 52 all the way down. Upper operator rolls barrel 2 into attachment 10; barrel 2 rolls up ramps 70 and falls into both wheel assemblies 50/60 and is cradled therein. The fork truck with attachment 10 and loaded barrel 2 moves out of the rick entry point and the operator then lowers attachment 10. Once positioned at ground level, the fork truck operator pulls the lever and raises the barrel 2 and the barrel 2 rolls out of attachment 10 and down a ramp onto rail line to building exit. The process can then be repeated, if desired.

It is noted that instead of moving the barrels to a position where they are placed on a rail line, the fork lift with barrel lifting attachment can be used to move barrels from one location in a rickhouse to another location in a rickhouse. To do so, as guided by fixed stop 16, the fork truck would be positioned at entry point of a rick with the barrel 2 to be moved. The fork truck operator insures that the piston 31 of hydraulic cylinder 30 is extended making rear wheels 52 all the way down. Upper operator rolls barrel 2 into attachment 10; barrel 2 rolls up ramp 70 and falls into both wheel assemblies 50/60. The fork truck with attachment 10 and loaded barrel 2 moves out of the rick entry point and the operator then lowers attachment 10. If needed, a person can then clock barrel 2 by rotating the barrel 2 manually until bung hole with bung 4 is in a desired position for its next storage location. The fork truck driver then raises forks 12 to desired rick height and positions the barrel 2 at the entry point of the rick for the new barrel 2 location. Once in position, the fork truck operator pulls the axis lever and the piston 31 of hydraulic cylinder 30 retracts thereby raising the rear wheel assembly 50. This causes the barrel 2 to lift out of all 4 wheels 52/62 and roll down ramps 70 and onto rails of the rick. The fork truck is moved out of rick and attachment 10 lowered so that the process can be repeated, if desired.

The foregoing detailed description is given primarily for clearness of understanding and no unnecessary limitations are to be understood therefrom for modifications can be made by those skilled in the art upon reading this disclosure and may be made without departing from the spirit of the invention.

1. A barrel lifting attachment for a fork lift, comprising:
a. a pair of forks, each fork having a top, a fork shank extending downward from the top, a fork blade extending outward from the fork shank and terminating in a fork tip;
b. a strength member connected between the pair of forks on insides of the fork blades toward the fork tips;
c. a frame connected between the pair of forks creating a frame pivot point, the connection being on insides of the fork blades at a location further from the fork tips than where the strength member is attached, the frame extending toward the fork shanks, the frame having a rear extension member extending away from the fork tips toward the fork shanks;
d. a piston mounting structure having a horizontal member with a bracket attached to each end of the horizontal member, each bracket attached to the fork shanks on their insides near the top of each fork;
e. a hydraulic cylinder having a non-piston end attached to the piston mounting structure's horizontal member such that a piston extends downward away from the horizontal member, the piston having a piston end, the piston end attached to the frame's rear extension member; the hydraulic cylinder operable to extend the piston so that the frame moves downward as allowed by the pivot point or operable to retract the piston so that the frame moves upward as allowed by the pivot point; and,
f. a pair of wedge members, each wedge member attached across from each other to a top surface of the fork blades at a location on the forks where the strength member is attached, the wedge members sloping upward from their front portions facing the fork tips back toward the fork shafts.

2. The barrel lifting attachment of claim 1, further comprising:
a. a front wheel assembly having a pair of mounting assemblies, each mounting assembly attached to the tops of the fork blades at a location further from the fork tips than the strength member, the front wheel assembly including a pair of front wheels, each front wheel attached to one of the mounting assemblies and located outside of both forks; and,
b. a rear wheel assembly having a pair of frame attachment assemblies, each frame attachment assembly attached to the frame at a location further from the fork tips than the front wheel assembly, the rear wheel assembly including a pair of rear wheels, each rear wheel attached to one of the attachment assemblies and located outside of the forks.

3. The barrel lifting attachment of claim 2, further comprising: fixed stops extending outward from each fork blade at a location between the front wheel assembly and the fork tips.

4. The barrel lifting attachment of claim 3, further comprising: a pair of barrel stop members, each barrel stop member attached to one of the fork shanks at a location toward the top of each fork shank.

5. The barrel lifting attachment of claim 4, where the piston end is attached to the frame's rear extension member using a pinned clevis member.

6. The barrel lifting attachment of claim 1, where the frame has a pair of front side members each front side member connected toward their fronts to the insides of the fork blades forming the frame pivot point, the front side members having a front member extending thereacross at a location to the rear of the frame pivot point, the front side members having a rear member extending thereacross at ends of the front side members, the rear member having the rear extension member attached thereto and extending away from the fork tips.

7. The barrel lifting attachment of claim 1, where the front and rear wheels are oriented so that a barrel received by the barrel lifting attachment is cradled by the front and rear wheels.

8. A barrel lifting attachment for a fork lift, comprising:
a. a pair of forks, each fork having a top, a fork shank extending downward from the top, a fork blade extending outward from the fork shank and terminating in a fork tip, the pair of forks in a fixed relationship to each other by having a strength member connected between the pair of fork blades toward the fork tips and a piston mounting structure attached to the fork shanks near the top of each fork;
b. a frame connected between the pair of forks creating a frame pivot point, the connection being at a location further from the fork tips than where the strength member is attached, the frame extending toward the fork shanks, the frame having a rear extension member extending away from the fork tips toward the fork shanks; and,
c. a hydraulic cylinder having a non-piston end attached to the piston mounting structure such that a piston extends downward away from the piston mounting structure, the piston having a piston end, the piston end attached to the frame's rear extension member; the hydraulic cylinder operable to extend the piston so that the frame moves downward as allowed by the pivot point or operable to retract the piston so that the frame moves upward as allowed by the pivot point.

9. The barrel lifting attachment of claim 8, further comprising: a pair of wedge members, each wedge member attached across from each other to a top surface of the fork blades at a location on the forks where the strength member is attached, the wedge members sloping upward from their front portions facing the fork tips back toward the fork shafts.

10. The barrel lifting attachment of claim 9, further comprising:
a. a front wheel assembly having a pair of mounting assemblies, each mounting assembly attached to the tops of the fork blades at a location further from the fork tips than the strength member, the front wheel assembly including a pair of front wheels, each front wheel attached to one of the mounting assemblies and located outside of both forks; and,
b. a rear wheel assembly having a pair of frame attachment assemblies, each frame attachment assembly attached to the frame at a location further from the fork tips than the front wheel assembly, the rear wheel assembly including a pair of rear wheels, each rear wheel attached to one of the attachment assemblies and located outside of the forks.

11. The barrel lifting attachment of claim 10, further comprising: fixed stops extending outward from each fork blade at a location between the front wheel assembly and the fork tips.

12. The barrel lifting attachment of claim 11, further comprising: a pair of barrel stop members, each barrel stop member attached to one of the fork shanks at a location toward the top of each fork shank.

13. The barrel lifting attachment of claim 12, where the piston end is attached to the frame's rear extension member using a pinned clevis member.

14. The barrel lifting attachment of claim 8, where the frame has a pair of front side members each front side member connected toward their fronts to the insides of the fork blades forming the frame pivot point, the front side members having a front member extending thereacross at a location to the rear of the frame pivot point, the front side members having a rear member extending thereacross at ends of the front side members, the rear member having the rear extension member attached thereto and extending away from the fork tips.

15. The barrel lifting attachment of claim 10, where the front and rear wheels are oriented so that a barrel received by the barrel lifting attachment is cradled by the front and rear wheels.

16. A method for a fork lift operator to operate a fork lift having the barrel lifting attachment of claim 9 attached to the fork lift to move a barrel from a first location to a second location comprising the steps of:
a. positioning the fork lift at the first location with the piston extended so that the rear wheel assembly is lowered and the fork tips are positioned so that a barrel can be received onto the fork blades;
b. rolling a barrel onto the fork blades and up the ramps to be received into front and rear wheel assemblies and be cradled therein by the front and rear wheels;
c. moving the fork lift to the second location and positioning the fork tips for removal of the barrel; and,
d. retracting the piston so that the rear wheel assembly is raised with respect to the front wheel assembly causing the barrel to then roll down the ramps and off the fork blades to be removed at the second location.

17. The method of claim 12 where, when the barrel is cradled by the front and rear wheel assemblies and supported by the front and rear wheels, the barrel is rotatable so that the barrel is clocked or positioned so that a bung inserted into the barrel is repositioned so that the bung is in the desired orientation when the barrel is removed at the second location.

18. The method of claim 12, where the second location is a rick in a rickhouse and where positioning the fork tips for removal of the barrel involves inserting the fork tips into the desired rick until the fixed stops prevent further insertion of the fork blades into the rick.

19. The method of claim 12, where the first location is a rick in a rickhouse and where positioning the fork tips so that a barrel can be received onto the fork blades involves inserting the fork tips into the desired rick until the fixed stops prevent further insertion of the fork blades into the rick.

20. The method of claim 15, where the second location is a different rick in a rickhouse and where positioning the fork tips for removal of the barrel involves inserting the fork tips into the desired different rick until the fixed stops prevent further insertion of the fork blades into the rick.
